(19) United States
(12) Patent Application Publication
(10) Pub. No.: US 2007/0169018 A1
(43) Pub. Date: Jul. 19, 2007

(54) Method and an apparatus for translating programming language code

(76) Inventor: Daniel R. Coward, San Francisco, CA (US)

Correspondence Address: SUN MICROSYSTEMS INC.;C/O PARK, VAUGHAN & FLEMING LLP, 2820 FIFTH STREET, DAVIS, CA, 95618-7759, US

(21) Appl. No.: 11/331,548

(22) Filed: Jan. 13, 2006

(51) Int. Cl. G06F 9/45

(52) U.S. Cl. 717/136

(57) ABSTRACT

One embodiment of the present invention provides a system that facilitates translating a first programming language file to form a second programming language file. During operation, the system receives the first programming language file. Next, the system translates structural elements in the first programming language file into the programming language of the second programming language file. Finally, the system saves the translated structural elements in the second programming language file.

### RELATED APPLICATION

The subject matter of this application is related to the subject matter in a co-pending non-provisional application by the same inventors as the instant application and filed on the same day as the instant application entitled, “Method and Apparatus for Translating an Application Programming Interface (API) Call,” having serial number TO BE ASSIGNED, and filing date TO BE ASSIGNED (Attorney Docket No. SUN06-0348).

### BACKGROUND

1. Field of the Invention

The present invention relates to programming languages for computer systems. More specifically, the present invention relates to a method and an apparatus for translating a programming language file written in a first programming language into a programming language file written in a second programming language, while preserving the original semantic meaning.

2. Related Art

As computer programming languages continue to proliferate, developers often need to translate a program written in one programming language into a different programming language. This translation may be necessary because of: business decisions to switch underlying platforms (which may not support programs written in some programming languages); the changing availability of developer skills to maintain and evolve programs written in specific programming languages; the desire of developers to program in a specific language; or a disparity of features between programming languages.

The goal of perfectly translating a complex source code program into an equivalently functioning program in a different target language is often very difficult to achieve. First, a program will typically utilize features of the underlying platform, and the underlying platform may not support the target new language. In addition, many programs use custom components which may not have equivalents in the new language. In other cases, developers will need to translate incomplete portions of programs that are constituent pieces of a larger program.

Numerous tools have been developed to automate the translation process. However, these tools often fail miserably in all but the simplest of translations. In particular, any program that has custom components, platform-specific Application Programming Interface (API) calls, or that is itself only an incomplete part of a larger complete program presents a significant problem to these translation tools. Typically, if these translation tools encounter code that they cannot translate, the translation tools simply return an error and do not continue with the translation process. More often then not, these tools fail to produce anything of value to the programmer.

Hence, what is needed is a method and an apparatus for translating a programming language file to a second programming language file that is resilient in the face of the problems listed above, and still produces code of value to the programmer.

### SUMMARY

One embodiment of the present invention provides a system that facilitates translating a first programming language file to form a second programming language file. During operation, the system receives the first programming language file. Next, the system translates structural elements in the first programming language file into the programming language of the second programming language file. Finally, the system saves the translated structural elements in the second programming language file.

In a variation on this embodiment, structural elements can include modules, classes, enumerations, and methods.

In a variation on this embodiment, the system also translates syntax elements of the first programming language file into the programming language of the second programming language file. The system then saves the translated syntax elements in the second programming language file.

In a further variation, these syntax elements can include functions and operations that are inherent to the programming language.

In a variation on this embodiment, the system also translates Application Programming Interface (API) calls from the first programming language file into the programming language of the second programming language file. The system then saves the translated API calls in the second programming language file.

In a further variation, translating a given API call involves performing a lookup for the given API call in a translation library to identify a comparable API call defined within the second programming language file.

In a variation on this embodiment, translating the API calls involves presenting the API call to a programmer, and receiving a comparable API call for the second programming file from the programmer.

In a further variation, the system saves the comparable API call within a translation library to facilitate subsequent translations of the API call.

One embodiment of the present invention provides a system that facilitates translating an Application Programming Interface (API) call for a first programming language into a comparable API call for a second programming language. The system operates by performing a lookup for the API call in a translation library to identify a comparable API call in the second programming language. The system then translates the API call into the comparable API call.

In a variation on this embodiment, prior to performing the lookup, the system presents the API call to a programmer. The system then receives a comparable API call from the programmer. Finally, the system saves the comparable API call to the translation library to facilitate subsequent translations of the API call.

In a variation on this embodiment, the system translates the API call at runtime to facilitate real-time API call translation on a web server. Note that rather than being limited to development time translations of source code, one embodiment of the present invention provides a system that dynamically interprets programs at runtime.

In a variation on this embodiment, the translation library is comprised of a plurality of extensible Markup Language (XML) files.

In a variation on this embodiment, the translation library includes behavioral elements of the API call. Note that this includes the ability for the library to contain software components that implement the more semantically difficult API call translations.

In a further variation, performing the lookup for the API call in the translation library involves identifying the comparable API call in the second programming language by matching behavioral elements of the API call with the behavioral elements of the comparable API call.

In a variation on this embodiment, the translation library includes a flag for the API call that indicates if the translation library includes a comparable API call.

### BRIEF DESCRIPTION OF THE FIGURES

FIG. 1 illustrates a programming environment in accordance with an embodiment of the present invention.

FIG. 2 presents a flowchart illustrating the process of translating a computer program in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the claims.

The data structures and code described in this detailed description are typically stored on a computer-readable storage medium, which may be any device or medium that can store code and/or data for use by a computer system. This includes, but is not limited to, magnetic and optical storage devices such as disk drives, magnetic tape, CDs (compact discs), DVDs (digital versatile discs or digital video discs), or any device capable of storing data usable by a computer system.

Overview

One embodiment of the present invention provides a system that facilitates translating a computer program written for a specific platform into a computer program for a different platform, and in a different programming language. The system can perform a complete translation, or the programmer can choose to stop the translation at any point during the translation process and work with the resulting output. For example, a programmer may choose to stop the translation process at the completion of the first step, which involves translating the program structure. If the programmer wishes to perform the bulk of the translation manually, stopping at this point provides the basic program framework which can be extremely helpful to the programmer.

One embodiment of the present invention also facilitates translating an Application Programming Interface (API) call for a programming language into a comparable API call for a second programming language. This system can be implemented as a translation library that can be used to translate programs from one programming language to another programming language, or from one computing platform to another computing platform, or for both. Additionally, the translation library can be used to provide run-time support for a system that performs run-time interpretation of computer programs.

Programming Environment

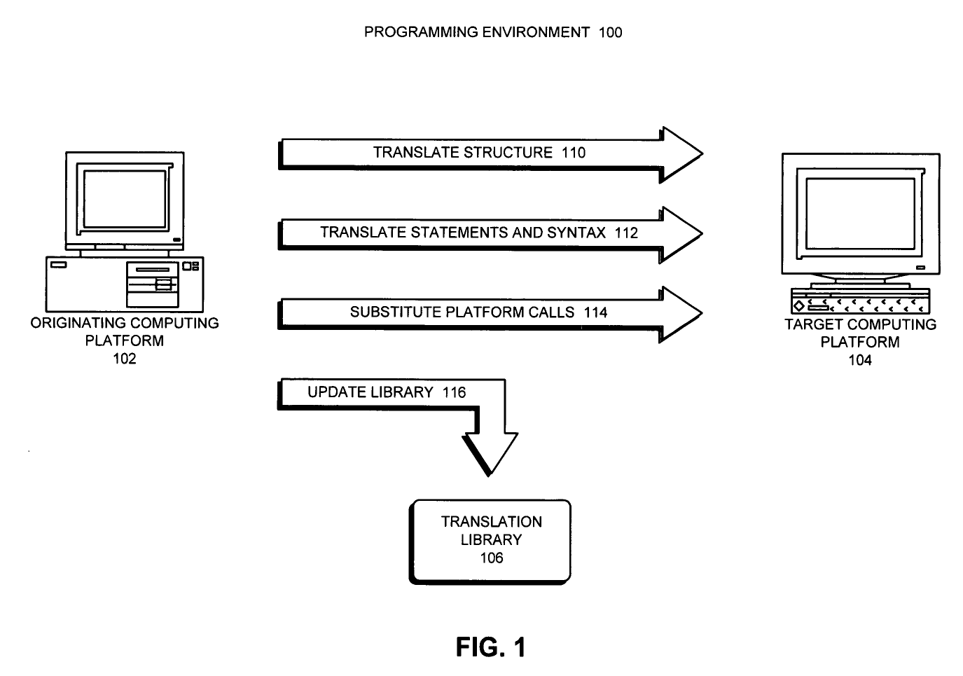

FIG. 1 illustrates a programming environment 100 in accordance with an embodiment of the present invention. Programming environment 100 is comprised of originating computing platform 102 and target computing platform 104. Additionally, programming environment 100 includes translation library 106. In one embodiment of the present invention, a program that was written for originating computing platform 102 is translated to a program for target computing platform 104. Note that originating computing platform 102 and target computing platform 104 can include different operating systems, different programming languages, or both. For example, in one embodiment of the present invention, a program written in C# for originating computing platform 102 which is running the Microsoft Windows operating system is translated into a program written in the Java programming language for target computing platform 104 which is running the Linux operating system. The terms JAVA, JVM and JAVA VIRTUAL MACHINE are trademarks of SUN Microsystems, Inc. of Santa Clara, Calif.

Translation library 106 provides a facility for determining comparable API calls across platforms and programming languages. In one embodiment of the present invention, translation library 106 resides on the system that the programmer is using to perform the translation, such as originating computing platform 102 or target computing platform 104. In another embodiment of the present invention, translation library 106 resides on a server on a network and is accessible to multiple developers. Note that in one embodiment of the present invention, translation library 106 resides on a server attached to the Internet.

As illustrated in FIG. 1, in one embodiment of the present invention, translating a program from originating computing platform 102 into target computing platform 104 can involve performing four separate steps, all of which are optional, and all of which provide output that can be used by a programmer. These steps include: (1) translating the structure 110, (2) translating statements and syntax 112, (3) substituting platform calls 114, and (4) updating the library 116. These steps are described in further detail below.

Translating a Computer Program

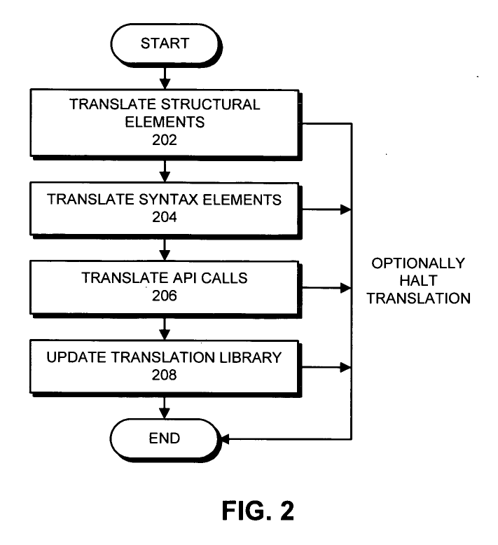

FIG. 2 presents a flowchart illustrating the process of translating a computer program in accordance with an embodiment of the present invention. Computer programs can be translated from the source form of one language into the source form of another language. The resulting program has equivalent or near-equivalent behavior to the original program. An example of such a process is the process by which programs written in the Visual Basic NET language can be translated into a program written in the Java programming language. This example will be used in the following description. Note that the present invention is not meant to be limited to conversions from Visual Basic .NET to the Java programming language, but in general can perform conversions from any programming language to any other programming language.

The originating and target languages include certain basic structural elements and properties common to most languages in use today. For example, the originating and target languages typically include:
The ability to subdivide programs into modules or classes, which are assumed to be collections of behavioral elements and/or data elements of the program (e.g., Java classes);
The ability utilize the behavioral elements and/or data elements of the modules or classes in another module or class (e.g., method invocation); and
The ability to utilize modules or classes that form part of the underlying execution platform (e.g., Java Platform API calls)

The system starts by translating the structural elements of the program (step 202). This process involves: understanding the form of the originator program's basic structural elements, including those described in the paragraph above; and translating these basic structural elements into an equivalent form in the target language. This process does not include the translation of the code that dictates the behavior of the application, only the structure. For example, in the case of a Visual Basic .NET to Java translation, this process converts all the Visual Basic.NET Modules, Enumerations, Structures, Classes, and their Visual Basic methods and variable members in the form of a collection of text files containing Visual Basic source code, into a collection of text files containing Java source code corresponding to Java classes with equivalent methods and member variables. The methods in the output Java classes, which later in the process will contain the behavior of the program, have not been implemented at this stage. Note that if a programmer so chooses, the programmer may stop the translation process at this point, and may work with the resulting structural output manually.

Next, the system translates the syntax elements of the program (step 204). This stage in the process looks into the behavioral elements of the originating program. For each behavioral element, the system decodes the behavioral element, based on the language syntax of the originating language, into a sequence of statements, and produces an equivalent sequence of statements based on the target language syntax. The system then adds the new sequence of statements into the corresponding behavioral element in the output structure of step 204. For example, the process can interpret all the statements within the methods defined in the Visual Basic program; produce equivalent sequences of statements in Java source code form; and insert them into the appropriate stub Java methods produced in step 202.

At this stage, it is unlikely the output program will compile and run on target computing platform 104. This is because the program is likely to be utilizing modules or classes and behavioral elements that rely on the underlying platform. For example, the originating Visual Basic application may be using .NET API calls for originating computing platform 102 that still need to be translated to appropriate calls in the target program for target computing platform 104. Again, note that the process can be terminated by the programmer at this point.

The system then translates the API calls using translation library 106 (step 206). This process involves examining all those statements in the originating program that make use of behavioral elements belonging to the underlying originating computing platform 102. In doing so, this process makes use of a translation library 106 of behavioral elements of the originating computing platform 102 to behavioral elements of the target computing platform 104. This translation library 106 may take the form of the behavioral knowledge of the originating computing platform 102 and the target computing platform 104 inside the head of a developer, or it may take the form of a local repository of text lookup functions, or the form of a web site containing method substitutions, which is available to a community of developers running the same process.

The process uses the translation library 106 to update those output statements created in step 204 by substituting the calls to behavioral elements in the originating computing platform 102 with calls to behavioral elements in the target computing platform 104. Those calls for which the translation library 106 has no substitution are flagged for attention. For example, translation library 106 may include a collection of eXtensible Markup Language (XML) files that contain .NET platform API call definitions and their Java equivalents. This step substitutes as many of the .NET platform API calls with Java API calls in the output Java source code as it can, and flags any calls for which it has no substitute for later review.

Finally, the system updates translation library 106 with any new findings during the translation process (step 208). If there are flagged elements remaining from step 206 within the statements of the output program, the system enumerates those statements and examines the flagged statements. This stage in the process involves studying the semantics of the behavioral element being called in the originating computing platform 102, and locating or producing the equivalent behavioral element based on the target computing platform 104. For example, this means locating the .NET API documentation for a flagged API call, and finding the semantically equivalent Java API call. If none exists, the programmer may write a Java component that can emulate it. At this point in the process there are two outcomes. The process may just use this information to substitute the call in the output program, or the process may update the library with this information and then update the output program.

In one embodiment of the present invention, translation library 106 is available to multiple programmers as part of a developer network on the Internet. In this embodiment, every time a programmer inserts information into the library regarding the behavioral elements of various API calls, the programmer is increasing the value of translation library 106 to other programmers who may subsequently need to translate a program with the same API calls.

In another embodiment of the present invention, translation library 106 resides on a web server to facilitate real-time interpretation of API calls. Note that rather than being limited to development time translations of source code, one embodiment of the present invention provides a system that dynamically interprets programs at runtime. This embodiment allows for a web server, with the addition of other translation or emulation software, to execute non-native programs that make platform-specific API calls. Furthermore, if translation library 106 is located on the Internet as part of a developer network as described previously, this can potentially decrease the amount of time between the release of a new program written in a non-native programming language of the web server and when the web server would be able to execute the non-native program with the help of translation library 106. As soon as a first programmer inserts the appropriate behavioral elements for each new API call into translation library 106, translation library 106 is able to translate or interpret those API calls for subsequent programmers or for the web server.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for translating a first programming language file to form a second programming language file, the method comprising:
receiving the first programming language file;
translating structural elements in the first programming language file into a programming language of the second programming language file; and
saving the translated structural elements in the second programming language file.

2. The method of claim 1, wherein structural elements can include:
modules;
classes;
enumerations; and
methods.

3. The method of claim 1, further comprising:
translating syntax elements of the first programming language file into the programming language of the second programming language file; and
saving the translated syntax elements in the second programming language file.

4. The method of claim 3, wherein syntax elements can include functions and operations that are inherent to the programming language.

5. The method of claim 1, further comprising:
translating Application Programming Interface (API) calls from the first programming language file into the programming language of the second programming language file; and
saving the translated API calls in the second programming language file.

6. The method of claim 5, wherein translating a given API call involves performing a lookup for the given API call in a translation library to determine a comparable API call defined within the second programming language file.

7. The method of claim 5, wherein translating the API calls involves:
presenting the API call to a programmer; and
receiving a comparable API call for the second programming file from the programmer.

8. The method of claim 7, further comprising saving the comparable API call within a translation library to facilitate subsequent translations of the API call.

9. A computer-readable storage medium storing instructions that when executed by a computer cause the computer to perform a method for translating a first programming language file to form a second programming language file, the method comprising:
receiving the first programming language file;
translating structural elements in the first programming language file into a programming language of the second programming language file; and
saving the translated structural elements in the second programming language file.

10. The computer-readable storage medium of claim 9, wherein structural elements can include:
modules;
classes;
enumerations; and
methods.

11. The computer-readable storage medium of claim 9, wherein the method further comprises:
translating syntax elements of the first programming language file into the programming language of the second programming language file; and
saving the translated syntax elements in the second programming language file.

12. The computer-readable storage medium of claim 11, wherein syntax elements can include functions and operations that are inherent to the programming language.

13. The computer-readable storage medium of claim 9, wherein the method further comprises:
translating Application Programming Interface (API) calls from the first programming language file into the programming language of the second programming language file; and
saving the translated API calls in the second programming language file.

14. The computer-readable storage medium of claim 13, wherein translating a given API call involves performing a lookup for the given API call in a translation library to determine a comparable API call defined within the second programming language file.

15. The computer-readable storage medium of claim 13, wherein translating the API calls involves:
presenting the API call to a programmer; and
receiving a comparable API call for the second programming file from the programmer.

16. The computer-readable storage medium of claim 15, wherein the method further comprises saving the comparable API call within a translation library to facilitate subsequent translations of the API call.

17. An apparatus for translating a first programming language file to form a second programming language file, comprising:
a receiving mechanism configured to receive the first programming language file;
a structural translation mechanism configured to translate structural elements in the first programming language file into a programming language of the second programming language file; and
a save mechanism configured to save the translated structural elements in the second programming language file.

18. The apparatus of claim 17, wherein structural elements can include:
modules;
classes;
enumerations; and
methods.

19. The apparatus of claim 17, further comprising:
a syntax translation mechanism configured to translate syntax elements of the first programming language file into the programming language of the second programming language file; and
wherein the save mechanism is further configured to save the translated syntax elements in the second programming language file.

20. The apparatus of claim 19, wherein syntax elements can include functions and operations that are inherent to the programming language.
